(19) United States
(12) Patent Application Publication
(10) Pub. No.: US 2026/0001029 A1
(43) Pub. Date: Jan. 1, 2026

(54) Methods and Systems for Purifying Carbon Dioxide

(71) Applicant: Air Products and Chemicals, Inc., Allentown, PA (US)

(72) Inventors: Timothy Christopher Golden, Nevez (FR); Mozhgan Alimohammadi Zanjani, Flemington, NJ (US); William J. Casteel, JR., Fountain Hill, PA (US); Tamara Lynn Daugherty, Kutztown, PA (US); William T. Kleinberg, Emmaus, PA (US); Garret C. Lau, New Tripoli, PA (US); Andrew Weaver, Surrey (GB)

(73) Assignee: Air Products and Chemicals, Inc., Allentown, PA (US)

(21) Appl. No.: 18/754,634

(22) Filed: Jun. 26, 2024

(51) Int. Cl. B01D 53/04

(52) U.S. Cl. CPC B01D 53/0462; B01D 2253/108; B01D 2256/22; B01D 2257/80

(57) ABSTRACT

A method includes contacting a feed stream comprising carbon dioxide, water vapor, and one or more impurities with a first adsorbent layer followed sequentially by a second adsorbent layer to produce a product carbon dioxide stream, a rich first adsorbent layer enriched in water vapor, and a rich second adsorbent layer enriched in the one or more impurities. The first adsorbent layer may include a first adsorbent selective for water, and the second adsorbent layer may include a second adsorbent selective for the one or more impurities.

### BACKGROUND

Industrial processes such as power generation and hydrogen production will need to capture carbon dioxide (CO2) to mitigate the effects of climate change. Captured CO2 may require dehydration prior to sequestration or utilization. One method of dehydration is temperature swing adsorption (TSA) in which a CO2 feed stream is passed over an adsorbent bed to remove impurities such as water vapor and alcohols. Once the adsorbent bed is loaded with impurities it may be taken offline and regenerated by heating and passing a clean gas over the adsorbent bed to remove the impurities into a spent regeneration gas. Water and alcohols may be removed from the spent regeneration gas by condensation. However, when alcohols are desorbed from the adsorbent bed they may react to form ethers too volatile to be removed by condensation, requiring those side reactions to be minimized or eliminated.

### SUMMARY

Disclosed herein are methods and systems for purifying a feed stream comprising CO2 by adsorbing water vapor and one or more impurities. The method may include contacting the feed stream with a first adsorbent later selective for water, then with a second adsorbent layer selective for the one or more impurities. The system may include an adsorbent bed with a first adsorbent later selective for water and a second adsorbent layer selective for the one or more impurities.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF DRAWINGS

These drawings illustrate certain aspects of some of the embodiments of the present disclosure and should not be used to limit or define the disclosure:

FIG. 1 is a schematic illustration depicting an embodiment of a CO2 purification process according to one or more aspects of the present disclosure.

FIG. 2 is a schematic illustration depicting a cross-section of a 4A adsorbent bed at two time points when fed with a feed stream comprising water vapor and methanol according to one or more aspects of the present disclosure.

FIG. 3 is a schematic illustration depicting a modification of FIG. 2 in which the adsorbent bed comprises a 3A adsorbent layer at the feed end and a 4A adsorbent layer at the product end.

### DETAILED DESCRIPTION

The present disclosure is directed to methods and systems for purifying a feed stream comprising CO2, water, and one or more impurities comprising sulfur oxides, nitrogen oxides, C5+ hydrocarbons, aromatic hydrocarbons, ammonia, amines, glycols, alcohols, ketones, aldehydes, acids, ethers, or combinations thereof. The methods and systems minimize or prevent side reactions involving the one or more impurities that may form compounds that cannot be removed from the feed stream and/or may damage adsorbent materials used in the process.

In accordance with the present embodiments, water and the one or more impurities may be removed from the feed stream in a first adsorption unit, producing a product CO2 stream. The feed stream may be at a temperature ranging from 5° C. to 50° C. (41° F. to 122° F.), or 20° C. to 40° C. (68° F. to 104° F.), and a pressure ranging from 10 to 70 bar (145 to 1015 psi), or 25 to 50 bar (362 to 725 psi). The feed stream may comprise at least 50% by volume CO2, or at least 80% by volume CO2, or at least 99% by volume CO2. The feed stream may comprise water ranging from 100 ppmv to 1.3 vol %, or from 1000 ppmv to 4000 ppmv. The feed stream may comprise the one or more impurities less than 500 ppmv, or less than 200 ppmv, or less than 100 ppmv. The adsorption unit may comprise a temperature swing adsorption (TSA) unit. The feed stream may enter the TSA unit from the bottom, also known as upflow, or from the top, also known as downflow. The TSA unit may comprise one or more beds, each bed comprising a first adsorbent layer and a second adsorbent layer.

The first adsorbent layer may be located upstream of the second adsorbent layer with respect to the flow direction of the feed stream through the bed. The first adsorbent layer may comprise a first adsorbent selective for water. The first adsorbent may have a low dynamic capacity for the one or more impurities to provide a clean-of-impurity layer of adsorbent in the bed. The first adsorbent may have a dynamic capacity for the one or more impurities of less than 5%, or less than 1%. The first adsorbent may have pores sized to accept water and exclude larger molecules such as the one or more impurities. The first adsorbent may have pore sizes ranging from 0.26 nm to 0.4 nm. The first adsorbent may have pore sizes smaller than the kinetic diameter of the one or more impurities. The first adsorbent may be a 3A molecular sieve zeolite. If the first adsorbent is 3A, it may be at least 60% exchanged with potassium, may comprise 10% or less binder (binder may comprise silica or silicone). The first adsorbent may comprise zeolites such as RHO, CHA, ITQ, analcime, bikitaite, erionite, ZK-5, merlinoite, phillipsite, yugawaralite, and small pore titanosilicates. The second adsorbent layer may comprise a second adsorbent layer may comprise a second adsorbent selective for the one or more impurities. The second adsorbent may have pore sizes greater than 0.4 nm, or pore sizes ranging from 0.4 nm to 6 nm. The second adsorbent may comprise 4A, AW-500, NaY, silica gel, activated carbon, activated alumina or metal organic frameworks. The bed may further comprise a pre-layer upstream of the first adsorbent layer, wherein the pre-layer comprises a water-stable adsorbent such as silica gel to remove harmful species such as SO2, NO2, and HCl in the feed gas prior to contacting the first adsorbent layer. The first adsorbent layer and the pre-layer may both comprise adsorbent materials with high stability at hot acidic conditions.

The TSA may be regenerated in a closed loop using a portion of the product CO2 stream. A portion of the product CO2 stream may be divided to form a regeneration gas stream. The regeneration gas stream may comprise a portion of the feed stream. The regeneration gas stream may comprise water greater than 10 ppmv, or greater than 50 ppmv, or ranging from 10 ppmv to 2000 ppmv, or ranging from 50 ppmv to 2000 ppmv, in order to slow any side reactions of the one or more impurities that produce water, such as dehydration of alcohols to form ethers. Water in the regeneration gas stream may be sourced from a separate stream of water or from the water vapor present in the feed stream. The TSA may be configured such that a bed rich in water and/or the one or more impurities is configured to receive the regeneration gas stream while a bed lean in water and/or the one or more impurities is configured to receive the feed stream. The TSA may have a bed on-stream (defined as the period of time in which a bed receives the feed stream and produces a dehydrated CO2 stream) for a period of time ranging from 2 hours to 24 hours, or from 4 hours to 12 hours. The regeneration gas stream may be heated and passed over the first adsorbent after it has become laden with water to drive water off the first adsorbent, and passed over the second adsorbent after it has become laden with the one or more impurities, and produce a spent regeneration gas enriched in water and the one or more impurities. The regeneration gas may be fed to the TSA on the product end and therefore contact the second adsorbent before contacting the first adsorbent. The regeneration gas may be fed to the TSA on the feed end. The adsorbent bed may be heated by indirectly transferring heat through the walls of the TSA. The temperature to regenerate the TSA may be ramped up and held at a first temperature to minimize the risk of side reactions in the one or more impurities as they are desorbed. The regeneration ramp rate may range from 0.5 to 10° C./min, or from 2 to 10° C./min. The first temperature may range from 100° C. to 150° C. The regeneration temperature may be held at the first temperature for a period of time ranging from 5 to 300 min, or from 5 to 60 min. The final target temperature to regenerate the TSA may range from 150° C. to 300° C. (302° F. to 572° F.), or from 150° C. to 200° C. (302° F. to 392° F.). The second adsorbent may be less selective for water than the one or more impurities to prevent the one or more impurities from being rolled up during regeneration at the final target temperature, in which water in the regeneration gas displaces adsorbed one or more impurities which may participate in unwanted side reactions.

The spent regeneration gas may be cooled to partially condense at least a portion of the water which may be separated and removed as a liquid condensate stream. The spent regeneration gas stream may be combined with the feed stream or recycled to the inlet of the TSA to improve overall CO2 recovery. The TSA may be regenerated at a pressure near the pressure of the feed stream to reduce or eliminate the power required to recycle the spent regeneration gas stream. The pressure of the regeneration gas stream may be within 5 bar of the pressure of the feed stream, or within 1.5 bar of the pressure of the feed stream.

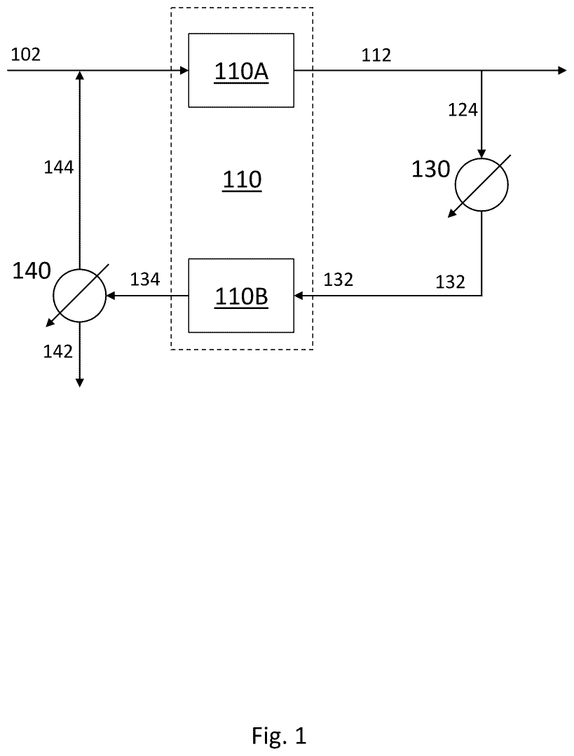

FIG. 1 is a schematic view depicting an embodiment of a CO2 purification process according to one or more aspects of the present disclosure. A feed stream 102 comprising carbon dioxide, water, and one or more impurities comprising sulfur oxides, nitrogen oxides, C5+ hydrocarbons, aromatic hydrocarbons, ammonia, amines, glycols, alcohols, ketones, aldehydes, acids, ethers, and combinations thereof, enters a lean bed 110A (lean with respect to water and the one or more impurities) of a TSA 110. The lean bed 110A may comprise a first adsorbent selective to water and a second adsorbent selective to the one or more impurities, removing water and the one or more impurities from the feed stream 102 and producing a product CO2 stream 112 depleted in water and the one or more impurities. The first adsorbent may be size selective to only accept water molecules into the pores and let the one or more impurities pass into the second adsorbent.

At least a portion of the product CO2 stream 112 may be divided to form a regeneration gas stream 124 which may be heated in heater 130 to form a heated regeneration gas stream 132. The heated regeneration gas stream 132 may be passed over a rich bed 110B (rich with respect to water and the one or more impurities) in the TSA 110 to desorb water from the first adsorbent and the one or more impurities from the second adsorbent, regenerating the rich bed 110B and producing a spent regeneration gas 134 enriched in water. The spent regeneration gas may be cooled in chiller 140 to partially condense water and the one or more impurities which may be removed as liquid condensate stream 142. An overhead stream 144 may exit the chiller 140 and be combined with the feed stream 102.

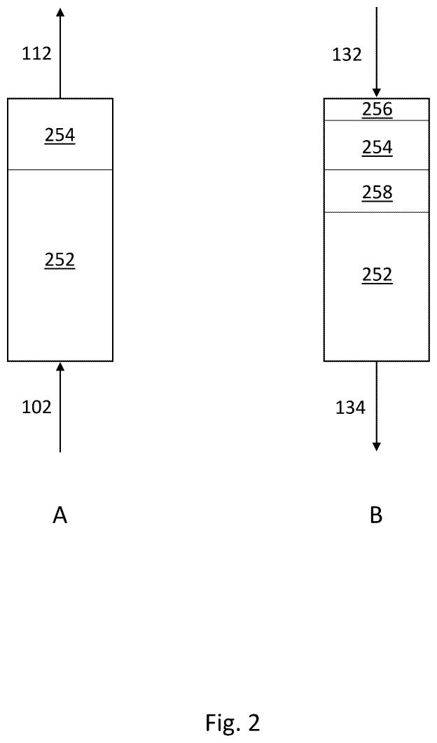

FIG. 2 is a schematic view depicting a cross-section of a 4A adsorbent bed at two time points when fed with a feed stream comprising water vapor and methanol according to one or more aspects of the present disclosure. The condition of the bed at the end of the feed phase is shown in A, and the condition of the bed partially through the regeneration phase is shown in B. At the end of the feed stage, the feed end of the bed may comprise a water-saturated 4A section 252 and the product end may comprise a methanol-saturated 4A section 254. When the bed is switched to regeneration mode with a regeneration gas 132 comprising dry CO2 product fed into the product end of the bed. Methanol may be driven off the adsorbent in the methanol-saturated 4A section 254, creating a methanol-depleted 4A section 256. Water may be driven off the adsorbent in the water-saturated 4A section 252, creating a water-depleted 4A section 258. At this point in the regeneration cycle, methanol from the methanol-saturated 4A section 254 may now enter empty 4A pores in the water-depleted 4A section 258 and be catalyzed to form dimethyl ether.

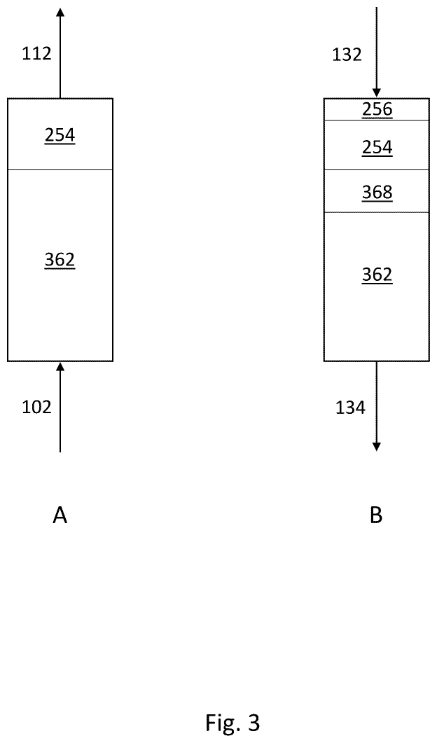

FIG. 3 is a schematic view depicting a modification of FIG. 2 in which the adsorbent bed comprises a 3A adsorbent layer at the feed end and a 4A adsorbent layer at the product end. The condition of the bed at the end of the feed phase is shown in A, and the condition of the bed partially through the regeneration phase is shown in B. At the end of the feed stage, the feed end of the bed may comprise a water-saturated 3A section 362 and the product end may comprise a methanol-saturated 4A section 254. When the bed is switched to regeneration mode with a regeneration gas 132 comprising dry CO2 product fed into the product end of the bed. Methanol may be driven off the adsorbent in the methanol-saturated 4A section 254, creating a methanol-depleted 4A section 256. Water may be driven off the adsorbent in the water-saturated 3A section 362, creating a water-depleted 3A section 368. In contrast with the single 4A bed in FIG. 2, methanol from the methanol-saturated 4A section 254 cannot enter empty 3A pores in the water-depleted 3A section 368 due to size limitations. Therefore, dimethyl ether formation during regeneration in a bed with 3A and 4A layers may be reduced or eliminated compared to regeneration in a bed with a single 4A layer.

Aspect 1: A method comprising contacting a feed stream comprising carbon dioxide, water vapor, and one or more impurities with a first adsorbent layer followed sequentially by a second adsorbent layer to produce a product carbon dioxide stream, a rich first adsorbent layer enriched in water vapor, and a rich second adsorbent layer enriched in the one or more impurities; wherein the first adsorbent layer comprises a first adsorbent selective for water; wherein the second adsorbent layer comprises a second adsorbent selective for the one or more impurities.

Aspect 2: A method according to Aspect 1, wherein the first adsorbent has a pore size ranging from 0.26 nm to 0.4 nm.

Aspect 3: A method according to Aspect 1 or Aspect 2, wherein the second adsorbent has a pore size greater than 0.4 nm.

Aspect 4: A method according to any of Aspects 1 to 3, wherein the first adsorbent has a dynamic capacity for the one or more impurities of less than 5%.

Aspect 5: A method according to any of Aspects 1 to 4, wherein the first adsorbent comprises 3A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, small pore titanosilicates, or combinations thereof.

Aspect 6: A method according to any of Aspects 1 to 5, wherein the second adsorbent comprises 4A, AW-500, NaY, silica gel, activated carbon, activated alumina, metal organic frameworks, or combinations thereof.

Aspect 7: A method according to any of Aspects 1 to 6, further comprising passing a regeneration gas stream over the second rich adsorbent layer followed sequentially by the first adsorbent layer to produce a spent regeneration gas enriched in water vapor and the one or more impurities, and the first adsorbent layer, and the second adsorbent layer.

Aspect 8: A method according to Aspect 7, further comprising heating the regeneration gas prior to passing over the second rich adsorbent layer to a hold temperature ranging from 100° C. to 150° C., holding the regeneration gas at the hold temperature for a period of time ranging from 5 to 300 min, and heating the regeneration gas a temperature ranging from 150° C. to 300° C. after the period of time has elapsed.

Aspect 9: A method according to Aspect 8, wherein the regeneration gas is heated at a rate ranging from 0.5 to 10° C./min.

Aspect 10: A method according to any of Aspects 7 to 9, wherein the regeneration gas comprises water vapor in a concentration ranging from 10 ppmv to 2000 ppmv.

Aspect 11: A method according to any of Aspects 7 to 10, further comprising combining the spent regeneration gas or a stream derived from the spent regeneration gas with the feed stream.

Aspect 12: A method according to Aspect 11, further comprising partially condensing the spent regeneration gas to remove a liquid condensate stream prior to combining the spent regeneration gas with the feed stream.

Aspect 13: A method according to any of Aspects 1 to 12, wherein the one or more impurities comprise sulfur oxides, nitrogen oxides, C5+ hydrocarbons, aromatic hydrocarbons, amines, glycols, alcohols, ketones, aldehydes, acids, ethers, and combinations thereof.

Aspect 14: A method according to any of Aspects 1 to 13, wherein the first adsorbent has a pore size smaller than the kinetic diameter of the one or more impurities.

Aspect 15: A method comprising contacting a feed stream comprising carbon dioxide, water vapor, and one or more impurities with a first adsorbent layer followed sequentially by a second adsorbent layer to produce a product carbon dioxide stream, a rich first adsorbent layer enriched in water vapor, and a rich second adsorbent layer enriched in the one or more impurities; passing the regeneration gas stream over the second rich adsorbent layer followed sequentially by the first adsorbent layer to produce a spent regeneration gas enriched in water vapor and the one or more impurities, and the first adsorbent layer, and the second adsorbent layer; partially condensing the spent regeneration gas stream to produce a liquid condensate stream and an overhead stream; and combining the overhead stream with the feed stream; wherein the regeneration gas is heated to a hold temperature ranging from 100° C. to 150° C., held at the hold temperature for a period of time ranging from 5 min to 300 min, and then heated to a temperature ranging from 150° C. to 300° C.; wherein the first adsorbent layer comprises a first adsorbent selective for water; wherein the second adsorbent layer comprises a second adsorbent selective for the one or more impurities.

Aspect 16: A method according to Aspect 15, wherein the first adsorbent has a pore size smaller than kinetic diameter of the one or more impurities.

Aspect 17: A method according to Aspect 15 or 16, wherein the second adsorbent has a pore size larger than the kinetic diameter of the one or more impurities.

Aspect 18: A method according to any of Aspects 15 to 17, wherein the first adsorbent comprises 3A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, small pore titanosilicates, or combinations thereof.

Aspect 19: A method according to any of Aspects 15 to 18, wherein the second adsorbent comprises 4A, AW-500, NaY, silica gel, activated carbon, activated alumina, metal organic frameworks, or combinations thereof.

Aspect 20: A method according to any of Aspects 15 to 19, wherein the regeneration gas is heated at a rate ranging from 0.5 to 10° C./min.

Aspect 21: A method according to any of Aspects 15 to 20, wherein the regeneration gas comprises water vapor in a concentration ranging from 10 ppmv to 2000 ppmv.

Aspect 22: A method according to any of Aspects 15 to 21, wherein the one or more impurities comprise sulfur oxides, nitrogen oxides, C5+ hydrocarbons, aromatic hydrocarbons, amines, glycols, alcohols, ketones, aldehydes, acids, ethers, and combinations thereof.

Aspect 23: A system comprising an adsorbent bed comprising a feed end, a product end, a first adsorbent layer and a second adsorbent layer; wherein the feed end of the adsorbent bed is configured to accept a feed stream comprising carbon dioxide, water vapor, and one or more impurities; wherein the product end of the adsorbent bed is configured to produce a product carbon dioxide stream depleted in water vapor and the one or more impurities; wherein the first adsorbent layer comprises a first adsorbent selective for water; wherein the second adsorbent layer comprises a second adsorbent selective for the one or more impurities.

Aspect 24: A system according to Aspect 23, wherein the first adsorbent has a pore size ranging from 0.26 nm to 0.4 nm.

Aspect 25: A system according to Aspect 23 or 24, wherein the second adsorbent has a pore size greater than 0.4 nm.

Aspect 26: A system according to any of Aspects 23 to 25, wherein the first adsorbent has a dynamic capacity for the one or more impurities of less than 5%.

Aspect 27: A system according to any of Aspects 23 to 26, wherein the first adsorbent comprises 3A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, small pore titanosilicates, and combinations thereof.

Aspect 28: A system according to any of Aspects 23 to 27, wherein the second adsorbent comprises 4A, AW-500, NaY, silica gel, activated carbon, activated alumina, metal organic frameworks, and combinations thereof.

Aspect 29: A system according to any of Aspects 23 to 28, wherein the one or more impurities are selected from sulfur oxides, nitrogen oxides, C5+ hydrocarbons, aromatic hydrocarbons, amines, glycols, alcohols, ketones, aldehydes, acids, and ethers.

Aspect 30: A system according to any of Aspects 23 to 29, further comprising a condenser in fluid flow communication with the product end of the adsorbent bed and the feed end of the adsorbent bed.

The ensuing detailed description provides preferred exemplary embodiments only, and is not intended to limit the scope, applicability, or configuration of the disclosure. Rather, the ensuing detailed description of the preferred exemplary embodiments will provide those skilled in the art with an enabling description for implementing the preferred exemplary embodiments of the disclosure. Various changes may be made in the function and arrangement of elements without departing from the spirit and scope of the disclosure, as set forth in the appended claims.

The articles “a” or “an” as used herein mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

The term “plurality” means “two or more than two.”

The adjective “any” means one, some, or all, indiscriminately of quantity.

The phrase “at least a portion” means “a portion or all.” The “at least a portion of a stream” has the same composition, with the same concentration of each of the species, as the stream from which it is derived.

As used herein, “first,” “second,” “third,” etc. are used to distinguish among a plurality of steps and/or features, and is not indicative of the total number, or relative position in time and/or space, unless expressly stated as such.

The terms “depleted” or “lean” mean having a lesser mole percent concentration of the indicated component than the original stream from which it was formed. “Depleted” and “lean” do not mean that the stream is completely lacking the indicated component.

The terms “rich” or “enriched” mean having a greater mole percent concentration of the indicated component than the original stream from which it was formed.

“Downstream” and “upstream” refer to the intended flow direction of the process fluid transferred. If the intended flow direction of the process fluid is from the first device to the second device, the second device is downstream of the first device. In case of a recycle stream, downstream and upstream refer to the first pass of the process fluid.

### EXAMPLE

The side reaction of methanol to form dimethyl ether:

$$2 CH3OH = C 2 H6O + H 2 O \qquad [ 1 ]$$

was measured experimentally on 4A and 3A zeolites with a K+ exchange of 70%. Both zeolites were first saturated with methanol by flowing helium containing 1200 ppmv of methanol for 2 hours. Both samples were then regenerated by flowing helium at a regeneration heating rate of 4° C./min to various final regeneration temperatures. The spent regeneration gas leaving the adsorbent was tested by gas chromatograph for dimethyl ether. Regeneration of the 4A zeolite with an empty bed contact time of 2.8 s (where the bed contact time is defined as the bed length divided by the superficial gas velocity) to a final temperature of 250° C. (482° F.) resulted in a conversion of 4.5% of the adsorbed methanol to dimethyl ether. The same experimental conditions for the 3A zeolite yielded no measured dimethyl ether. The lower reaction rate on 3A is the result of a smaller pore diameter of 0.3 nm (compared to the 0.4 nm pores for 4A) making it difficult for methanol to reach the catalytic sites within the pores. For longer empty bed contact times of 16.7 s and 29.3 s, the 3A showed conversion of methanol to dimethyl ether of 0.2% and 0.7%, respectively. This shows that the reaction rate is much lower on 3A than 4A, but not zero. When the empty bed contact time of 29.3 s was repeated with a final temperature of 200° C. (392° F.), there was no measurable conversion of methanol to dimethyl ether for 3A. This indicates that holding the regeneration temperature below 200° C. (392° F.) while methanol is being desorbed will minimize or prevent the side reaction to form dimethyl ether. Finally, the empty bed contact time of 29.3 s was repeated with a staged regeneration cycle: heating at 4° C./min until reaching 150° C. (302° F.), then holding at 150° C. (302° F.) for 2 hours, then heating at 4° C./min until reaching 250° C. (482° F.). Compared to holding the regeneration temperature at 200° C. (392° F.), the amount of methanol desorbed from the 3A using the staged regeneration cycle was higher (100% vs 65%) while still having no measurable conversion of methanol to dimethyl ether.

The capacity of 3A zeolite for methanol was measured in a series of experiments varying the amount of K+ exchange. Table 1 shows the methanol capacity in wt % at 1 h and 4 h of exposure to helium with 1200 ppmv methanol. Lower values of methanol capacity are desirable in choosing the 3A zeolite for a water selective adsorbent. For comparison, a water adsorption on 3A is complete (22 wt %) within 30 minutes.

TABLE 1

| K+ Exchange | Methanol Capacity at 1 h | Methanol Capacity at 4 h |
|---|---|---|
| Level | (wt %) | (wt %) |
| 23% | 6.4 | 15.6 |
| 63% | 1.7 | 5.9 |
| 67% | 2.2 | 4.1 |

While the principles of the disclosure have been described above in connection with preferred embodiments, it is to be clearly understood that this description is made only by way of example and not as a limitation of the scope of the disclosure.

1. A method comprising:
contacting a feed stream comprising carbon dioxide, water vapor, and one or more impurities with a first adsorbent layer followed sequentially by a second adsorbent layer to produce a product carbon dioxide stream, a rich first adsorbent layer enriched in water vapor, and a rich second adsorbent layer enriched in the one or more impurities;
wherein the first adsorbent layer comprises a first adsorbent selective for water;
wherein the second adsorbent layer comprises a second adsorbent selective for the one or more impurities.

2. The method of claim 1, wherein the first adsorbent has a pore size smaller than kinetic diameter of the one or more impurities.

3. The method of claim 1, wherein the first adsorbent comprises 3A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, small pore titanosilicates, or combinations thereof.

4. The method of claim 1, wherein the second adsorbent comprises 4A, AW-500, NaY, silica gel, activated carbon, activated alumina, metal organic frameworks, or combinations thereof.

5. The method of claim 1, further comprising passing a regeneration gas stream over the second rich adsorbent layer followed sequentially by the first adsorbent layer to produce a spent regeneration gas enriched in water vapor and the one or more impurities, and the first adsorbent layer, and the second adsorbent layer.

6. The method of claim 1, wherein the one or more impurities comprise sulfur oxides, nitrogen oxides, C5+ hydrocarbons, aromatic hydrocarbons, amines, glycols, alcohols, ketones, aldehydes, acids, ethers, and combinations thereof.

7. The method of claim 5, further comprising heating the regeneration gas prior to passing over the second rich adsorbent layer to a hold temperature ranging from 100° C. to 150° C., holding the regeneration gas at the hold temperature for a period of time ranging from 5 to 300 min, and heating the regeneration gas to a temperature ranging from 150° C. to 300° C. after the period of time has elapsed.

8. The method of claim 7, wherein the regeneration gas is heated at a rate ranging from 0.5 to 10° C./min.

9. The method of claim 5, wherein the regeneration gas comprises water vapor in a concentration ranging from 10 ppmv to 2000 ppmv.

10. The method of claim 5, further comprising partially condensing the spent regeneration gas to produce a liquid condensate stream and an overhead stream; and combining the spent regeneration gas with the feed stream.

11. A method comprising:
contacting a feed stream comprising carbon dioxide, water vapor, and one or more impurities with a first adsorbent layer followed sequentially by a second adsorbent layer to produce a product carbon dioxide stream, a rich first adsorbent layer enriched in water vapor, and a rich second adsorbent layer enriched in the one or more impurities;
passing the regeneration gas stream over the second rich adsorbent layer followed sequentially by the first adsorbent layer to produce a spent regeneration gas enriched in water vapor and the one or more impurities, and the first adsorbent layer, and the second adsorbent layer;
partially condensing the spent regeneration gas stream to produce a liquid condensate stream and an overhead stream; and
combining the overhead stream with the feed stream;
wherein the regeneration gas is heated to a hold temperature ranging from 100° C. to 150° C., held at the hold temperature for a period of time ranging from 5 min to 300 min, and then heated to a temperature ranging from 150° C. to 300° C.;
wherein the first adsorbent layer comprises a first adsorbent selective for water;
wherein the second adsorbent layer comprises a second adsorbent selective for the one or more impurities.

12. The method of claim 11, wherein the first adsorbent has a pore size smaller than kinetic diameter of the one or more impurities.

13. The method of claim 11, wherein the second adsorbent has a pore size larger than the kinetic diameter of the one or more impurities.

14. The method of claim 11, wherein the first adsorbent comprises 3A zeolites, RHO zeolites, CHA zeolites, ITQ zeolites, analcime zeolites, bikitaite zeolites, erionite zeolites, ZK-5 zeolites, merlinoite zeolites, phillipsite zeolites, yugawaralite zeolites, small pore titanosilicates, or combinations thereof.

15. The method of claim 11, wherein the second adsorbent comprises 4A, AW-500, NaY, silica gel, activated carbon, activated alumina, metal organic frameworks, or combinations thereof.

16. The method of claim 11, wherein the regeneration gas is heated at a rate ranging from 0.5 to 10° C./min.

17. The method of claim 11, wherein the regeneration gas comprises water vapor in a concentration ranging from 10 ppmv to 2000 ppmv.

18. The method of claim 11, wherein the one or more impurities comprise sulfur oxides, nitrogen oxides, C5+ hydrocarbons, aromatic hydrocarbons, amines, glycols, alcohols, ketones, aldehydes, acids, ethers, and combinations thereof.

19. A system comprising:
an adsorbent bed comprising a feed end, a product end, a first adsorbent layer and a second adsorbent layer;
wherein the feed end of the adsorbent bed is configured to accept a feed stream comprising carbon dioxide, water vapor, and one or more impurities;
wherein the product end of the adsorbent bed is configured to produce a product carbon dioxide stream depleted in water vapor and the one or more impurities;
wherein the first adsorbent layer comprises a first adsorbent selective for water;
wherein the second adsorbent layer comprises a second adsorbent selective for the one or more impurities.

20. The system of claim 19, further comprising a condenser in fluid flow communication with the product end of the adsorbent bed and the feed end of the adsorbent bed.
